(19) United States
(12) Patent Application Publication
(10) Pub. No.: US 2016/0066567 A1
(43) Pub. Date: Mar. 10, 2016

(54) STABLE DEFOAMERS FOR HIGH ELECTROLYTE AGRICULTURAL FORMULATIONS

(71) Applicant: Wacker Chemical Corporation, Adrian, MI (US)

(72) Inventors: Lingrong GU, Ypsilanti, MI (US); John RAWLS, Adrian, MI (US)

(21) Appl. No.: 14/501,413

(22) Filed: Sep. 30, 2014

Related U.S. Application Data
(60) Provisional application No. 62/047,754, filed on Sep. 9, 2014.

(51) Int. Cl. A01N 25/00

(52) U.S. Cl. CPC A01N 25/00

(57) ABSTRACT

High electrolyte agrochemical formulations with reduced foaming are formulated with a polyorganosiloxane defoamer containing defoaming polyoxyalkylene ether groups and tertiary aminoalkyl groups. The defoamers are stable in the high electrolyte formulation.

### CROSS-REFERENCE TO RELATED APPLICATIONS

This application claims the benefit of U.S. provisional application Ser. No. 62/047,754 filed Sep. 9, 2014, the disclosure of which is hereby incorporated in its entirety by reference herein.

### BACKGROUND OF THE INVENTION

1. Field of the Invention

The invention pertains to preventing foam in high electrolyte agricultural formulations.

2. Description of the Related Art

In the agricultural field, use of pesticides is now ubiquitous. The term “pesticide” includes chemicals and chemical compositions used to treat, mitigate, and hopefully eradicate pests generally, and includes herbicides, insecticides, fungicides, algaecides, etc. Yet more broadly, the term “agrochemical” refers to pesticides as described above, and other biologically active substances, for example growth regulators, growth retarders, growth hormones, etc. All these are organic compounds. Thus, in the broad term “agrochemical” as used herein, the agrochemicals are biologically active organic compounds.

Of the agrochemicals, insecticides and herbicides see the most widespread use. One herbicide in particular, glyphosate, has revolutionized agriculture to the extent that companies have genetically engineered crop seeds to be resistant to glyphosate. Thus, glyphosate herbicide can be sprayed directly onto a crop such as genetically engineered corn, which will survive, while broadleaf weeds and grassy weeds, which would reduce the yield of corn, will be stunted or killed. However, the widespread use of glyphosate has also begun to foster a new flora of glyphosate-resistant weeds, requiring higher levels of glyphosate to be effective. Other agrochemicals have had some of the same types of problems as glyphosate herbicides.

Virtually all agrochemicals are viewed by the public as well as by government agencies, to be a necessary evil, to be used in the smallest amount possible. “Organic” fruits, vegetables, wheat, and even meat products are now common in grocery stores. These products are sold at elevated prices which are necessary due to the lower yields and more intensive human interaction which are required when agrochemicals are not used. The commercial viability of such products reflects a common desire to use the least amount and least harmful agrochemicals as is possible.

Thus, agrochemical manufacturers and formulators are constantly searching for more effective herbicides which are useful in lesser amounts, and are also hopefully both less toxic and less persistent in the environment. In addition, manufacturers and formulators have sought means to get the most performance out of existing agrochemicals. For example, in the 1980's, it was found that organic vegetable oils could enhance the grass killing ability of cyclohexenone herbicides, and more recently, it has been discovered that inorganic salts such as ammonium sulfate can enhance the activity of glyphosate herbicides.

Many herbicides are themselves ionic, and ionic surfactants are often used with these and other agrochemicals, resulting in formulations of high electrolyte content. This is even more so when soluble ionic enhancers such as ammonium sulfate are added. Examples of such formulations include U.S. Pat. Nos. 6,117,820; 6,849,577; and 8,551,533, which are incorporated herein by reference.

The surfactants (emulsifiers) used in high electrolyte formulations are, in general, different from those used in low- or no-electrolyte formulations. The higher electrolyte content in general causes many emulsifiers to lose their activity over time. For example, U.S. published application 2012/0071321 A1 indicates that for solid, particulate agrochemicals in high electrolyte formulations, conventional dispersants such as ethylene oxide/propylene oxide block copolymers, aryl sulfonates, and lignosulfonates fail as dispersants. In U.S. published application 2012/0289402 A1, the Applicants even define the phrase “electrolyte-tolerant surfactant,” and recommend alkyl polyglycosides, while in WO 2010/102102 A1, alkyl polyglycosides are also used, in combination with ethoxylated fatty tallow amines. The amount of surfactant in some compositions may be 300 g per liter or higher.

The nature of the organic agrochemical and the various surfactants which are present in the formulations frequently result in compositions with severe to moderate foaming during dilution or use. For decades, antifoams have been used in many industries to prevent foam, or defoamers have been used to ensure rapid foam collapse. In many cases, one component operates both as an antifoam and a defoamer. In dishwashing compositions, for example, and in black liquor processing in the Kraft paper process, silicone defoamers have long been used, including very effective defoamers based on mixtures of silica and organopolysiloxanes; see U.S. Pat. Nos. 6,004,918, 7,550,514, and 7,566,750, for example. U.S. published application 2012/0289402 discloses use of traditional silicone defoamers made by reacting a silicone resin, a silicone fluid, and a particular metal oxide, for example. Defoamers in high electrolyte agrochemical formulations are also disclosed in WO 2010/102102 A1.

The problem with high electrolyte agrochemical formulations is that they are generally already formulated as a liquid, and any defoamer added must not only be effective, but also stable. It has been found that many excellent defoamers are ineffective in high electrolyte agrochemical formulations or become ineffective after only modest storage at room temperature. Defoamers based on reaction products of silica with silicone fluids and resins are often solids, and their preparation involves several process steps which renders their use less economical.

It would be desirable to provide defoamers which are highly effective in preventing foam in high electrolyte formulations while also being stable in such formulations. It would be further desirable to provide defoamers which are liquid and/or soluble in agrochemical formulations, and which do not involve multiple processing steps or processing steps of long duration in their preparation.

### SUMMARY OF THE INVENTION

It has now been surprisingly and unexpectedly discovered that organopolysiloxanes bearing both tertiary aminoalkyl groups and polyoxyalkylene glycol groups containing residues of both ethylene oxide and a higher alkylene oxide, are stable and effective antifoams in high electrolyte content agrochemical formulations, and are easily preparable.

### DETAILED DESCRIPTION OF THE PREFERRED EMBODIMENTS

The invention is thus directed to high electrolyte agrochemical compositions containing an antifoam, (“defoamer”, hereafter), which is an organopolysiloxane bearing both tertiary aminoalkyl groups and defoamingpolyoxyalkylene polyether groups, and to a method of stabilizing a high electrolyte composition against foaming by the addition of such an organopolysiloxane thereto.

The term “high electrolyte” composition is not capable of precise definition, but is a well-known term in the art, and high electrolyte compositions contain a high proportion of ionic substances. See, for example, U.S. published application 2012/0071321 A2, particularly paragraphs [0036]-[0039], and U.S. published application 2012/0289402 A1, particularly paragraphs [0014] and [0028], both references incorporated by reference herein. For purposes of the present application, a high electrolyte composition will be considered one which meets any of the following: 1) the composition is a dilutable composition which contains an agrochemical ingredient which is ionic in and of itself; 2) the composition contains a non-ionic agrochemical ingredient and an ionic surfactant; 3) the composition contains an ionic agrochemical and an ionic surfactant; 4) the composition corresponds to any of the above, or contains only non-ionic agrochemical ingredients and only non-ionic surfactants, but contains at least 0.1 mol/1 of a water soluble salt. It should be understood that regardless of what definition is used, the formulation is one which has need for a defoamer, either when used alone, i.e. diluted for use, or when used in conjunction with a separately supplied adjuvant, for example a crop oil, another herbicide, etc.

A rich electrolyte formulation is defined herein as a composition which has a conductivity of 1 mS/cm or more, preferably 10 mS/cm or more, yet more preferably 50 mS/cm or more, especially 100 mS/cm or more, and more especially, in order of increasing preference, 1 S/cm, or 5 S/cm, or 10 S/cm or more. The invention includes the use of the claimed antifoam in both high electrolyte and rich electrolyte formulations. High electrolyte and rich electrolyte formulations are not necessarily distinct from each other in formulation ingredients, but differ in the means used to define them. In the present application, the term “high electrolyte” will include both high electrolyte and rich electrolyte formulations unless indicated to the contrary, and “high electrolyte” in general has the meaning customary ascribed to it by those skilled in the art. For example, a dilutable glyphosate salt solution, even without ionic adjuvants, is considered by the art to be a high electrolyte composition, as are also glyphosate compositions with ionic enhancers such as ammonium sulfate, ammonium nitrate, soluble fertilizers, soluble micronutrients, or any combination thereof.

A wide variety of agrochemicals can be present in the composition, and this includes agrochemicals which are soluble, which are emulsifiable, are dispersible, or some combination thereof. The agrochemical may be liquid or solid prior to admixture with the remaining compositional ingredients.

Specific examples of pesticide compounds that can be used herein as an agrochemical include, but are not limited to, herbicides and growth regulators such as, a phenoxy acetic acids, phenoxy propionic acids, phenoxy butyric acids, benzoic acids, triazines and s-triazines, substituted ureas, uracils, pyridate, amitrole, clomazone, fluridone, norflurazone, dinitroanilines, isopropalin, oryzalin, pendimethalin, prodiamine, trifluralin, glyphosate, glufosinate, imazapyr, imazethapry, dicamba, fomesafen, 2,4-dichlorophenoxyacetic acid, sulfonylureas, imidazolinones, clethodim, diclofop-methyl, fenoxaprop-ethyl, sethoxydim, dichiobenil, isoxaben, and bipyridylium compounds. Fungicide compositions that can be used with the compounds of the present invention include, but are not limited to, aldimorph, tridemorph, dodemorph, dimethomorph, flusilazol, azaconazole, cyproconazole, epoxiconazole, furconazole, propiconazole, tebuconazole, imazalil, thiophanate, benomyl carbendazim, chlorothialonil, dicloran, trifloxystrobin, fluoxystrobin, dimoxystrobin, azoxystrobin, furcaranil, prochloraz, flusulfamide, famoxadone, dodicin and dodine.

Insecticide, larvacide, miticide and ovacide compounds which can be used with the compositions of the present invention include, but are not limited to, Bacillus thuringiensis (Bt), spinosad, abamectin, doramectin, lepimectin, pyrethrins, amitraz, boric acid, imidacloprid, diazinon, kelevan, izoxathion, chlorpyrifos, clofentezine, lambda-cyhalothrin, permethrin, bifenthrin, cypermethrin, and the like.

Of the foregoing compounds, the water-soluble herbicides are particularly advantageous for incorporation in the agrochemical formulation of this invention with glyphosate, glufosinate, imazapyr, imazethapyr, dicamba, fomesafen and 2,4-dichlorophenoxyacetic acid being preferred. It should be understood that these preferred herbicides include all of their salts and other forms which are known in the art. A most preferred agrochemical is glyphosate, N-phosphonomethyl glycine, and its water soluble salts, e.g. the trimethylsulfonium, isopropanolamine, sodium, potassium, and ammonium salts: fomesafen, in particular its sodium salt; glufosinate, and in particular its ammonium salt; paraquat dichloride; and bentazone and its sodium salt. By the term “agrochemical active” is meant the organic agrochemical itself, without adjuvants, solubilizers, enhancers, surfactants, etc.

The agrochemical active may also be present as a dispersion of particles containing adsorbed or absorbed agrochemical, e.g. fumed silica particles, or particles which are microcapsules containing the agrochemical active ingredient. Examples of water insoluble agrochemicals which may be incorporated in this manner include diuron, linuron, sulfometuron, chlorsulphuron, metsulfuron, chlorimuron, atrazine, simazine, quizalofop, butroxydim, nicosulfuron, primsulfuron, bensulfuron, ametryn, pendimethalin, isoproturon, chlortoluron, diflufenican, mesotrione, aclonifen, flurochloridone, oxyfluorfen, isoxaflutole, imazamox and thifensulfuron. This list is exemplary and not limiting.

The agrochemical formulations generally contain a surfactant to keep the agrochemical actives solubilized, stably emulsified, or dispersed. There are a wide variety of surfactants available, including non-ionic, cationic, anionic, and zwitterionic surfactants. The number of surfactants which are suitable for use in high or rich electrolyte systems is more limited, as many conventional surfactants are not stable in such formulations. Examples of useful surfactants in high electrolyte compositions may be found U.S. Pat. No. 6,849,577, column 4, beginning at line 12, continuing to column 5, line 22, and in U.S. Pat. No. 8,551,533 at column 4, line 20, continuing to line 46 of column 5, and the patent references cited therein, which are incorporated herein by reference. Alkyl glycosides are preferred surfactants. The amount of surfactants required is easily determined by simply mixing the ingredients and observing freedom from sedimentation and separation over time. Some degree of separation is acceptable, but not preferred, so long as the emulsion or dispersion may be reconstituted by simple agitation, for example shaking or mixing with a simple drill motor-mounted propeller stirrer or the like, i.e. without the necessity to use a rotor/stator mixer or other type of high shear mixer or homogenizer. The amount of surfactant will also depend upon the concentration of the agrochemical ingredient and other components, but is, in most cases, from 0.05 to 50 weight percent, preferably 0.5 to 20 weight percent, more preferably from 1 to 10 weight percent, and most preferably from 1 to 5 weight percent, based on the weight of the total formulation. The use of more than one type of surfactant is contemplated.

Solvents and cosolvents may be present if necessary. Cosolvents are generally at least partially water soluble, but virtually insoluble organic solvents are also useful. In the latter case, the solvent generally dissolves the agrochemical active, and it is the solution of the solvent and active ingredient which is emulsified or dispersed. Other solvents and cosolvents may be partially soluble or can be totally miscible with the aqueous phase, and may partially or fully solubilize the agrochemical ingredient, as a result of which there may accordingly be less agrochemical to be dispersed as an emulsion or dispersion. Suitable solvents and co-solvents are well known, and may, for example, be alkanols, glycols, glycol ethers, esters, ketones, paraffinic and naphthenic hydrocarbons, terpenes, mineral oils, vegetable oils, liquid fatty acids, and the like. Preferably, no solvents or cosolvents are used. When solvents or cosolvents are used, they are preferably used in amounts of 0.1 to 50 weight percent, based on the total weight of the formulation, more preferably 0.1 to 40, 30, or 20 weight percent, yet more preferably less than 15, 10, or 5 weight percent.

Organic herbicide enhancers may be present. These are well known in the art, and are organic compounds which generally have no or little biological activity by themselves, but which enhance the effectiveness of the agrochemical active. The nature of such enhancers varies with the nature of the agrochemical itself, and can be selected based on the teachings of the art. Also suitable, and somewhat related, are substances such as “sticking agents,” which facilitate adherence of the agrochemical formulation to substrates, and make the formulation more resistant to being washed away by rain, irrigation, etc., so that it can be more effectively absorbed, e.g. by leaves and root systems. Film forming water soluble or water insoluble vinyl addition polymers can be used for such purposes, e.g. polyacrylic acid and polyvinyl alcohol.

Ionic, generally inorganic substances can be present in the high electrolyte compositions. Some of these substances are described in the literature and are known non-organic enhancers of the agrochemical active's activity, while others may be present to serve another purpose, e.g. as fertilizer, etc. Suitable water-soluble electrolytes which can be incorporated in the adjuvant composition of this invention may, for example, comprise a cation or a mixture of cations which may include cations of aluminium, ammonium, antimony, barium, bismuth, calcium, cesium, copper, iron, lithium, magnesium, nickel, potassium, rubidium, silver, sodium, strontium, zinc or zirconium; and an anion or a mixture of anions which may include anions such as acetate, sulfate, chloride, nitrate, thionate, tartrate, benzenesulfonate, benzoate, bicarbonate, bisulfite, borates, phosphate, phosphite, sulfamate, etc.

Preferred water-soluble electrolytes (a) are those in which the cations are inorganic and/or those which are inorganic salts. Among the preferred water-soluble electrolytes are known and conventional fertilizers and plant nutrients such as ammonium sulfate, ammonium chloride, ammonium nitrate, ammonium phosphate, urea ammonium nitrate (UAN), nitrophosphate, calcium nitrate, sodium nitrate, monocalcium phosphate monohydrate, triple superphosphate, or TSP, potassium chloride, potassium sulfate, potassium nitrate, potassium phosphate, calcium chloride, and the like. Of these, the ammonium salts, in particular, ammonium sulfate, ammonium chloride, ammonium nitrate, ammonium phosphate, urea ammonium nitrate and mixtures thereof, are especially advantageous water-soluble electrolytes (a) for incorporation in the adjuvant composition of this invention.

The total amount of electrolyte(s) (a) incorporated in the adjuvant composition of this invention can be at fairly high levels, e.g., those typical of fertilizer use, and can range, e.g., from 5 to 60 weight percent, more preferably from 10 to 50 weight percent, and most preferably from 20 to 40 weight percent, based on the total weight of the formulation.

Other types of additives which are conventionally used may be present in the inventive compositions, or the compositions may be free of such additive types, or free of individual additives of a given type. Examples of such additives include solid dispersing aids such as hydrophilic or partly water wettable silica, pH adjusting additives such as acids or bases, buffer systems, pigments or colorants such as dyes, etc.; spreading agents, fragrances, humectants, anti-freeze agents such as urea, ethylene glycol and propylene glycol, rheology agents for increasing or decreasing viscosity, anti-spray drift agents, and the like.

The organopolysiloxane defoamers useful in the present invention contain at least one tertiary aminoalkyl group, and at least one polyoxyalkylene polyether moiety which contains both ethylene oxide residues and higher alkylene oxide residues.

The tertiary aminoalkyl groups are preferably those of the formula

R₂N—(R¹—NR²)ₙ—R^{1′}—

where R is a hydrocarbon group, or an alkanol group, preferably or a C₁₋₂₀ alkyl or alkanol group, more preferably a C₁₋₈ alkyl group, and most preferably methyl, ethyl, n-propyl, i-propyl, n-butyl. or i-butyl. R may also be C₃₋₈ alkenyl, C₅₋₈ cycloalkyl, C₅₋₈ cycloalkenyl, C₆₋₁₄ aryl, C₇₋₁₆ alkaryl, or C₇₋₁₆ arylalkyl. These hydrocarbon substituents are not limiting. Methyl and ethyl are particularly preferred. When R is an alkanol group, it is preferably an ethanol, propanol, or butanol group, each of which, if desired, may be oxyalkylated.

R¹ and R^{1′} are each a divalent hydrocarbon radical, and may be aliphatic, cycloaliphatic, arylaliphatic, alkaryl, and the like. R¹ and R^{1′} may contain heteroatoms N, O, S, especially when R¹ or R¹⁻ is aryl. R¹ and R¹⁻ are preferably C₁₋₁₀ alkylene or C₅₋₁₀ cycloalkylene, more preferably C₁₋₈ alkylene, or C₅₋₈ cycloalkene, and most preferably C₁₋₄ alkylene, with methylene, ethylene, propylene, and butylene being preferred. When heteroatoms are contained in an aliphatic carbon chain, the heteroatoms are non-adjacent. All groups are thus preferably free of unstable heteroatom-containing linkages such as azo and peroxo moieties.

The value of n is preferably 0-10, more preferably 0-4, and most preferably 0-2.

R² is hydrogen, or preferably a hydrocarbon group, the latter optionally substituted by —NHR groups or —OH groups. The hydrocarbon groups R² are preferably aliphatic or cycloaliphatic, more preferably C₁₋₁₈ alkyl, more preferably C₁₋₈ alkyl, and most preferably C₁₋₄ alkyl, e.g. methyl, ethyl, propyl, butyl, 2-hydroxypropyl, 2-hydroxyethyl, and the like. R², for example, may be R.

The tertiary aminoalkyl group may be covalently bonded to the organopolysiloxane by an Si—C bond with a carbon atom of R^{1′}, or R^{1′} may itself have contained a —NHR or —OH group, which may then have been linked to the organopolysiloxane through a group resulting from the reaction of the —NHR or —OH group with an isocyanate group. e.g. by a urethane linkage or urea linkage. The tertiary aminoalkyl groups are preferably located at the chain termini of a linear or branched organopolysiloxane, may be pendent to the chain, or may also be incorporated into the backbone of the organopolysiloxane. Most preferably, all amino groups are tertiary amino groups. Preferred aminoalkyl compounds which may be used to incorporate aminoalkyl groups are 1,7-bis(dimethylamino)-4-aza-heptane, and 1,7-bis(dimethylamino)-4-(2-hydroxypropyl)-4-aza-heptane, having the respective formulae:

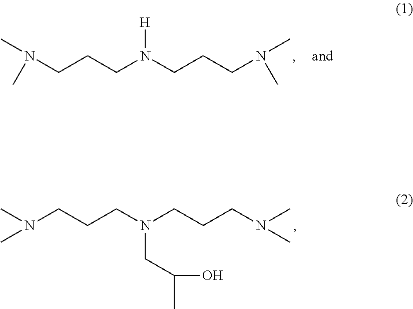

Any suitable method may be used to incorporate the tertiary aminoalkyl groups into the organopolysiloxane defoamer, and suitable methods are known to those skilled in the art. These include, for example, reaction of silanol or alkoxysilyl-functional silanes or siloxanes with alkoxysilanes bearing tertiary aminoalkyl groups; linking a tertiary aminoalkyl group containing compound also bearing at least one primary or secondary amino group to an organopolysiloxane bearing a silanol functionality or an alkanol or alkylamine functionality by means of a diisocyanate; silylating an unsaturated aminohydrocarbon such as N, N-dimethyl allylamine or N,N-dimethyl-2-aminoethyl-3-amino-1-propene with a Si—H functional organopolysiloxane, etc. Methods of incorporation which are widely applicable are shown in the Examples. However, any suitable method may be used. The tertiary aminoalkyl groups may be present in salt form, i.e. as the corresponding ammonium salt, with counter ions such as chloride, bromide, acetate, propionate, sulfate, etc.

The organopolysiloxane defoamers preferably contain at least one polyoxyalkylene polyether group which contains both oxyethylene groups and a higher oxyalkylene group, preferably oxypropylene groups, and less preferably oxybutylene groups. The organopolysiloxane defoamers may also include other polyoxyalkylene groups as well, for example (homo)polyoxyethylene polyethers, (homo)polyoxypropylene ethers, or (homo)polyoxybutylene ethers. Most preferably, at least one of the polyoxyalkylene groups is an “in-chain” polyoxyalkylene group. Most preferably, the polyoxyalkylene groups include at least one and preferably 2-8 in-chain groups and no, one, or two terminal polyoxyalkylene groups. Pendent (“on-chain”) polyoxyalkylene groups may be present as well.

Thus, the polyoxyalkylene groups may be block EO/PO moieties, block/random EO/PO moieties, or any combination thereof so long as the resultant end products have defoaming ability. The amount and relative proportions of the repeating EO, PO, BO, etc. oxyalkylene groups can be easily determined by routine experimentation, preferably with the particular high electrolyte agrochemical formulation with which it is to be used. However, additional guidance may be found in “Nonionic Surfactants,” Martin J. Schick, Ed., CRC Press, © 1987, and the early patent literature directed to block and block-random polyether surfactants, for example the patents of D. R. Jackson and L. G. Lundsted, including U.S. Pat. Nos. 2,674,619, 2,677,700, and 3,036,118 of Wyandotte Chemical Corporation.

As indicated previously, organopolysiloxanes with separate (homo)polyoxyethylene and (homo)polyoxypropylene chains in the same molecule may also function as defoamers. However, such moieties are more difficult to prepare, and thus co-polyoxyalkylene polyethers containing both oxyethylene and oxypropylene groups, preferably in block form, are preferred. Oxy(higher alkylene) groups are necessary, for example oxypropylene or oxybutylene groups. Products with only polyoxyethylene groups cannot perform a defoaming function. The number of higher oxyalkylene groups is performance limited (sufficient for defoaming activity), but is preferably from 3 to 100, more preferably 8-50, yet more preferably 10-40, and most preferably 15-30. A preferred organo polyorganosiloxane component of the invention is WETSOFT NE 820, available from Wacker Chemie A.G., Munich, Germany.

The polyoxyalkylene groups may be incorporated into the organopolysiloxane by numerous methods well known to the skilled artisan, for example by equilibration, condensation with appropriate substituted alkoxysilanes, etc., but a preferred incorporation method is by hydrosilylation of a monoether or diether of allyl alcohol and polyoxyalkylene glycol. The allyl-functional monoethers are particularly easy to prepare by oxyalkylation of allyl alcohol, and many of such monoethers are commercially available. The Si—H functional compound may be a conventional, Si-H-functional organopolysiloxane. This method, when a monoether is used, results in an organopolysiloxane terminated on both ends by an OH-functional polyether or having pendent polyether groups, where the linkage to the organopolysiloxane is through a hydrolysis-stable SiC-bonded propyl group. This intermediate may then be chain extended by reaction with a di- or polyisocyanate, preferably a diisocyanate such as 1,6-hexanediisocyanate (HDI), 2,6- or 2,4-toluenediisocyanate (TDI), isophorone diisocyanate (IPDI), 1,8-octanediisocyanate, 2,2′-, 2,4′-, and 4,4′-diphenylmethanediisocyanate (MDI), and the like. Modified isocyanates such as urethane-modified, carbodiimide-modified, biuret- and isocyanurate-modified isocyanates may also be used, but are not preferred. Aliphatic isocyanates are preferred, most preferably HDI.

During or following reaction with the di- or polyisocyanate, the tertiary aminoalkyl-functional compound can be added. This overall synthetic scheme, which is preferred, allows for synthesis of a variety of random or block copolymers.

A further method of synthesis is to react an unsaturated tertiary alkylamine and an unsaturated polyether with an organopolysiloxane bearing more than two Si—H functionalities.

The organopolysiloxane component to which the tertiary aminoalkyl groups and polyoxyalkylene groups are bound, are preferably non-resinous, linear or lightly branched organopolysiloxanes which are conventional, and as organo groups, preferably contain predominately C₁₋₁₈ alkyl groups, more preferably C₁₋₄ alkyl groups. Preferably, the majority of the alkyl groups are methyl or ethyl groups, most preferably methyl groups. Other organo groups are of course possible, and these include cycloalkyl groups, aryl groups, arylalkyl groups, and alkaryl groups, all of which are well known in silicone chemistry, and many of which are identified herein as R groups. For reasons of economy, most of the organo groups, preferably all organo groups except aminoalkyl and polyoxyalkylene groups, are methyl groups. Non-limiting examples of organopolysiloxanes useful as reactants in the hydrosilylation reaction with an unsaturated alkylene ether of a polyoxyalkylene polyether are linear silicones of the formula

HMe₂Si—(OSiMe₂)ₘ-OSiMe₂H

where Me is a methyl group and m is an integer from 2 to 1000, preferably 10-500, and most preferably 20-100. A value of about 50 has proven to be quite effective. These are linear organopolysiloxanes. Branched organopolysiloxanes may be easily visualized by replacing one or more of the repeating —(OSiMe₂)- structure with an —O—(SiMeH)—, an —O—(SiMe₂)ₘ—OSiMe₂H structure, or, when a non-functional branch is contemplated, with an —O—(SiMe₂)ₘ-OSiMe₃ structure. Linear organopolysiloxanes are generally preferred. When branched organopolysiloxanes are employed, the amount of branching is preferably less than 5 branches on average per molecule, and more preferably 2 or fewer branches.

The preferred molecules, as synthesized, have bis-urethane linking groups linking the organopolysiloxane component with the polyoxyalkylene component, and preferably urethane or urea groups linking the aminoalkyl group.

One example of such a defoamer is:

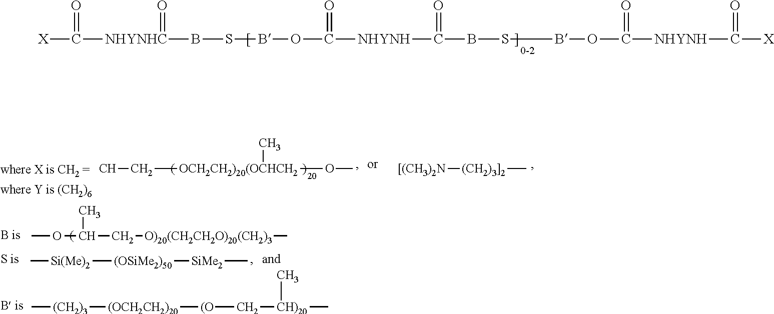

This defoamer can be prepared by hydrosilylating an allyl ether of a block copolyether containing, for example, 20 oxyethylene and 20 oxypropylene units with a polydimethylsiloxane terminated with hydrogendimethylsiloxy groups and having 50 repeating dimethylsiloxy groups, in the presence of a hydrosilylation catalyst, as disclosed in U.S. Published Application No. 2011/0021688, which is incorporated herein by reference. The intermediate product, now terminated with hydroxyl-functional polyether groups, is reacted with a slight stoichiometric deficiency of 1,6-hexamethylene diisocyanate and a stoichiometric excess of 1,7-bis(dimethylamino)-4-aza-heptane, in the presence of a bismuth urethane reaction-promoting catalyst. No residual —NCO groups can be detected. Volatiles are removed under vacuum. In a particularly preferred synthesis, siloxane copolymers obtainable by reacting in a first step, organopolysiloxanes which have at least one silicon-bonded hydrogen atom per molecule, preferably at least two silicon-bonded hydrogen atoms, with substantially linear oligomeric or polymeric compounds of the general formula

R³-(A-CₙH₂ₙ)ₘ-A¹-H (I)

where R³ is a monovalent optionally substituted hydrocarbyl radical capable of adding Si—H groups in a hydrosilylation reaction, preferably a hydrocarbyl radical having an aliphatic carbon-carbon multiple bond, A is a bivalent polar organic radical selected from the group consisting of —O—, —C(O)—O—, —O—C(O)—, —O—C(O)—O—, —C(O)—NH—, —NH—C(O)—, urethane radical and urea radical, preferably an oxygen atom —O—,

A¹ is a bivalent polar organic radical selected from the group consisting of —O—, —NH— and —NR′— (where R′ is a monovalent hydrocarbyl radical of 1 to 18 carbon atoms), preferably an oxygen atom —O—,

n is an integer from 1 to 20, preferably 1 to 4 and more preferably 2 or 3,

m is a positive integer, preferably 5 to 50,

and a second step, reacting

the resulting H-A¹-group-containing intermediates with organic di- or polyisocyanates, with the proviso that m and n are such that the resulting product contains both polyoxyethylene groups and poly(oxy(higher)alkylene) groups, and exhibits defoaming activity.

Preferably, the water content of the compounds and used for preparing the siloxane copolymers of the present invention is less than 2000 ppm by weight, more preferably less than 1500 ppm, and most preferably less than 1000 ppm, all based on the total weight of the reactants. The water content is measured at room temperature (20° C.) and the pressure of the ambient atmosphere (1020 hPa).

The siloxane copolymers of the present invention preferably have a viscosity of 1000 to 100,000,000 mPas at 25° C. and more preferably 10,000 to 10,000,000 mPa at 25° C.

The first step of the process preferably utilizes linear, cyclic or branched organopolysiloxanes (1) constructed of units of the general formula

$${R}_{c}^{4} {H}_{f} {SiO}_{\frac{4 - e - f}{2}} , \qquad ( II )$$

where R⁴ in each occurrence may be the same or different and is a monovalent optionally substituted hydrocarbyl radical having 1 to 18 carbon atoms per radical, for example with the definition of R or R³

e is 0, 1, 2 or 3,

f is 0, 1 or 2,

and the sum total of e+f is 0, 1, 2 or 3,

with the proviso that each molecule has at least one silicon-bonded hydrogen atom and preferably 2 or more silicon-bonded hydrogen atoms.

Preferred organopolysiloxanes (1) have the general formula

H_{g}R_{3-g}SiO(SiR⁴₂O)ₒ(SiR⁴HO)ₚSiR⁴_{3-g}H_{g} (III)

where R⁴ is as defined above,

g is 0, 1 or 2,

o is 0 or an integer from 1 to 1500, and

p is 0 or an integer from 1 to 200, with the proviso that each molecule has at least one silicon-bonded hydrogen atom and preferably two or more silicon-bonded hydrogen atoms.

Formula (III) of this invention is to be understood as meaning that the o units of —(SiR⁴₂O)— and the p units of —(SiR⁴HO)— may have any desired distribution in the organopolysiloxane molecule.

It is particularly preferable for g in the formula (III) to be 1, for p in the formula (III) to be 0 and for α,ω-dihydropolydiorganosiloxanes and especially α,ω-dihydropolydimethylsiloxanes to be used as organopolysiloxanes (1). The organopolysiloxanes (1) preferably have an average viscosity of 10 to 1000 mPas at 25° C., preferably 50 to 1000 mPas at 25° C. and more preferably 60 to 600 mPas at 25°. C.

Examples of R⁴ radicals are those given previously, preferably alkyl radicals such as methyl, ethyl, n-propyl, isopropyl, 1-n-butyl, 2-n-butyl, isobutyl, tert-butyl, n-pentyl, isopentyl, neopentyl, and tert-pentyl radicals, hexyl radicals such as n-hexyl, heptyl radicals such as n-heptyl, octyl radicals such as n-octyl and isooctyl radicals such as 2,2,4-trimethylpentyl, nonyl radicals such as n-nonyl, decyl radicals such as n-decyl, dodecyl radicals such as n-dodecyl, and octadecyl radicals such as n-octadecyl; cycloalkyl radicals, such as cyclopentyl, cyclohexyl, cycloheptyl and methylcyclohexyl radicals and; aryl radicals such as phenyl, naphthyl, anthryl and phenanthryl radicals; alkaryl radicals such as the o-, m-, p-tolyl radicals, xylyl radicals and ethylphenyl radicals; and aralkyl radicals such as the benzyl, α-phenylethyl and β-phenylethyl radicals.

Examples of substituted R⁴ radicals are haloalkyl radicals such as the 3,3,3-trifluoro-n-propyl, 2,2,2,2′,2′,2′-hexafluoroisopropyl, and heptafluoroisopropyl radicals and haloaryl radicals such as the o-, m- and p-chlorophenyl radicals.

The R⁴ radical is preferably a monovalent hydrocarbyl radical of 1 to 6 carbon atoms, methyl being particularly preferred.

Examples of R⁴ radicals fully apply to R′ radicals.

R³ is preferably a monovalent hydrocarbyl radical possessing an aliphatic carbon-carbon multiple bond. Examples of R³ radicals are alkenyl radicals, such as the vinyl, 5-hexenyl, cyclohexenyl, 1-propenyl, allyl, 3-butenyl and 4-pentenyl radicals, and alkynyl radicals such as the ethynyl, propargyl and 1-propynyl radicals. The R³ radical is preferably an alkenyl radical, especially an w-alkenyl radical and the allyl radical is particularly preferred.

Preference for use as oligomeric or polymeric polyethers (2) is given to aliphatic unsaturated alcohols of the general formula

H₂C═CH—R²—(OC₁H₂ₙ)ₘ—OH (IV)

where R² is a bivalent hydrocarbyl radical of 1 to 20 carbon atoms, preferably a radical of the formula —CH₂—, —CH(CH₃)— or —C(CH₃)₂— and n and m are each as defined above.

Preferred examples of polyethers are those of the general formula

H₂C═CH—R²—(OCH₂CH₂)ₐ[OCH₂CH(CH₃)]_{b}—OH (IV′)

where R² is as defined above and

a and b are 0 or an integer from 1 to 200, with the proviso that the sum total of a+b is not less than 5 and is preferably from 5 to 50. When used as the sole polyoxyalkylene groups, it is preferable for b to be at least 5, more preferably at least 8, and more preferably 10-30. A value of 20 has been found to work well, when both oxyethylene and oxypropylene groups are found together in a block arrangement (totaling 40 oxyalkyl groups).

The amounts in which the compounds (2) are used in the first step are preferably in the range from 1.0 to 4.0 and preferably from 1.3 to 2.5 mol of R³ radical, which is preferably a radical having an aliphatic carbon-carbon multiple bond and preferably is an w-alkenyl radical, per gram atom of silicon-bonded hydrogen in organopolysiloxane (1).

The first step preferably utilizes catalysts (3) which promote the addition of silicon-bonded hydrogen onto aliphatic unsaturation. Useful catalysts (3) include all catalysts useful in promoting the addition of silicon-bonded hydrogen onto aliphatic unsaturation. The catalysts are preferably a metal from the group of the platinum metals or a compound or complex from the group of the platinum metals. Examples of such catalysts are metallic and finely divided platinum, which may be on supports, such as silicon dioxide, aluminum oxide or activated carbon, compounds or complexes of platinum, such as platinum halides, examples being PtCl₄, H₂PtCl₆.6H₂O, Na₂PtCl₄.4H₂O, platinum-olefin complexes, platinum-alcohol complexes, platinum-alkoxide complexes, platinum-ether complexes, platinum-aldehyde complexes, platinum-ketone complexes, including reaction products of H₂PtCl₆.6H₂O and cyclohexanone, platinum-vinylsiloxane complexes, such as platinum-1,3-divinyl-1,1,3,3-tetramethyldisiloxane complexes with or without detectable inorganically bound halogen, bis(gammapicoline)platinum dichloride, trimethylenedipyridineplatinum dichloride, dicyclopentadieneplatinum dichloride, dimethyl-sulfoxideethyleneplatinum(II) dichloride, cycloocta-dieneplatinum dichloride, norbornadieneplatinum dichloride, gamma-picolineplatinum dichloride, cyclo-pentadieneplatinum dichloride, and also reaction products of platinum tetrachloride with olefin and primary amine or secondary amine or primary and secondary amine, such as the reaction product of platinum tetrachloride dissolved in 1-octene with sec-butylamine or ammonium-platinum complexes.

The amount of catalyst (3) in the first step is preferably in the range from 1 to 50 weight ppm (parts by weight per million parts by weight) and more preferably in amounts of 2 to 20 ppm, all calculated as elemental platinum and based on the total weight of organopolysiloxanes (1) and compounds (2).

The first step of the process is preferably carried out at the pressure of the ambient atmosphere i.e., at 1020 hPa absolute, say, but can also be carried out at higher or lower pressures. Furthermore, the first step of the process is preferably carried out at a temperature in the range from 60° C. to 140° C. and more preferably at a temperature in the range from 80° C. to 120° C.

The second step of the process preferably utilizes organic compounds (5), which have two or more isocyanate groups per molecule, that have the general formula

O═C═N—R⁵—N═C═O (V)

where R⁵ is a bivalent hydrocarbyl radical having 4 to 40 carbon atoms per radical.

Examples of organic compounds (5) are hexamethylene diisocyanate, isophorone diisocyanate, tolylene 2,4-diisocyanate, tolylene 2,6-diisocyanate, phenylene 1,3-diisocyanate, 4,4′-methylenebis(cyclohexyl isocyanate), 4,4′-methylenebis(phenyl isocyanate) and dimethylphenyl diisocyanate. Aliphatic diisocyanates are preferred.

Preferably, the amount of organic compounds (5) used in the second step is in the range from 0.5 to 1.0 mol and more preferably in the range from 0.8 to 1.0 mol of isocyanate group per mole of H-A¹ group in the intermediate (4).

The reaction in the second step of the process preferably utilizes condensation catalysts (6), such as di-n-butyltin dilaurate, tin(II) octoate, dibutyltin diacetate, potassium octoate, zinc dilaurate, bismuth trilaurate or tertiary amines, such as dimethylcyclohexylamine, dimethylaminopropyldipropanolamine, pentamethyldipropylenetriamine, N-methylimidazole or N-ethylmorpholine, which catalyze the formation of urethane groups.

A preferred siloxane copolymer is obtained by a first step of reacting an α,ω-dihydropolydiorganosiloxane (1) in excess with a polyether (2) of the formula (IV) or (IV′), preferably the latter, and a second step of reacting the intermediate (4), an HO-polyether-polysiloxane-polyether-OH, with a diisocyanate (5) of the formula

(V) to introduce urethane groups into the siloxane copolymer. In the process, free polyether from the 1st step is also bound by urethane formation:

CH₂═CH—R²—(OCₙH₂ₙ)ₘ—OC(O)NH—R³—NHC(O)O[(CₙH₂ₙO)ₘ—R²—CH₂CH₂—R₂SiO(R₂SiO)ₒ—R₂SiO—CH₂CH₂—R²—(OCₙH₂ₙ)ₘ—OC(O)NH—R³—NHC(O)O]ₓ(CₙH₂ₙO)ₘ—R²—CH═CH₂ (VI),

where R, R², R³, n, m and o are each as defined above and x is 0 or an integer from 1 to 20, preferably 0 or an integer from 1 to 4.

The urethane groups in the hydrophilic siloxane copolymers of the present invention can act as donors and acceptors in the formation of hydrogen bonds.

The second step of the process according to the present invention, in addition to the organic compounds (5), may utilize still further compounds (7) which are reactive toward isocyanate groups. Examples of further compounds (7) are those selected from the group of formulae

R⁶-(A-CₙH₂ₙ)ₘ-A¹-H (VII),

HO—R⁷—NR⁶—R⁷—OH (VIII),

HO—R⁷—NR⁶₂ (IX),

HO—R⁸(NR⁶₂)₂ (X),

HO—R⁸—(NR⁶₂)₃ (XI),

(HO)₂R⁹—NR⁶₂ (XII),

HNR⁶₂ (XIII)

where R⁶ is a hydrogen atom or an R radical which may optionally contain one or more nitrogen atoms,

R⁷ is a bivalent hydrocarbyl radical having 1 to 10 carbon atoms per radical,

R⁸ is a trivalent organic radical having 1 to 100 carbon atoms per radical, preferably a trivalent hydrocarbyl radical having 1 to 100 carbon atoms, which contains one or more oxygen atoms,

R⁹ is a tetravalent organic radical having 1 to 100 carbon atoms per radical, preferably a tetravalent hydrocarbyl radical having 1 to 100 carbon atoms which contains one or more oxygen atoms, and A¹, n and m are each as defined above, with the proviso that at least one tertiary amino group is present.

Examples of compounds of the formula (VII) are polyoxyethylene glycol methyl ether, polyoxyethylene glycol butyl ether, polyoxyethylene/polyoxypropylene methyl ether, and polyoxypropylene glycol methyl ether.

Examples of compounds of the formula (VIII) are N-methyldiethanolamine, N-methyldipropanolamine, dimethylaminopropyldipropanolamine, N-dodecyldiethanol-amine and N-stearyldipropanolamine.

Examples of compounds of the formula (IX) are N,N-dimethylethanolamine, N,N-diethylpropanolamine, N,N-dimethylaminopropylmethylethanolamine and dimethyl-2-(2-aminoethoxy)ethanol.

Examples of compounds of the formula (X) are 1,5-bis(dimethylamino)pentan-3-ol, 1,5-bis(methylamino)-pentan-3-ol, 1,7-bis(dimethylamino)heptan-4-ol and N,N-bis(3-dimethylaminopropyl)-N-isopropanolamine.

Examples of compounds of the formula (XI) are 2,4,6-tris(dimethylaminomethyl)phenol, 1,1,1-tris(dimethyl-aminomethyl)methanol and 2,4,6-tris(dimethylamino-methyl)cyclohexanol.

Examples of compounds of the formula (XII) are N,N-bis(dimethylaminopropyl)-3-aminopropane-1,2-diol, N,N-bis(dimethylaminopropyl)-2-aminopropane-1,3-diol, N,N-bis(3-dimethylaminopropyl)carbaminomonoglyceride.

Examples of compounds of the formula (XIII) are dibutylamine, octylamine, benzylamine, 3-(cyclohexyl-amino)propylamine, 2-(diethylamino)ethylamine, dipropylenetriamine, isophoronediamine, dimethylamino-propylmethylamine, aminopropylmorpholine, N,N-bis(di-methylaminopropyl)amine, dimethylaminopropylamine.

Compounds of the formula (VIII) to (XIII) provide a way of incorporating protonatable nitrogen in the siloxane copolymer.

Compounds of the formula (VII) are used in the second step in amounts of preferably 0 to 2 mol and more preferably 0 to 1 mol of H-A¹ group per mole of H-A¹ group in compound (2).

Compounds of the formula (VIII) are used in the second step in amounts of preferably 0 to 2 mol and more preferably 0 to 1 mol of HO group per mole of H-A¹ group in compound (2).

Compounds of the formula (IX) are used in the second step in amounts of preferably 0 to 2 mol and more preferably 0 to 1 mol of HO group per mole of H-A¹ group in compound (2).

Compounds of the formula (X) are used in the second step in amounts of preferably 0 to 2 mol and more preferably 0 to 1 mol of HO group per mole of H-A¹ group in compound (2).

Compounds of the formula (XI) are used in the second step in amounts of preferably 0 to 2 mol and more preferably 0 to 1 mol of HO group per mole of H-A¹ group in compound (2).

Compounds of the formula (XII) are used in the second step in amounts of preferably 0 to 2 mel and more preferably 0 to 1 mol of HO group per mole of H-A¹ group in compound (2).

Compounds of the formula (XIII) are used in the second step in amounts of preferably 0 to 2 mol and more preferably 0 to 1 mol of HN group per mole of H-A¹ group in compound (2).

Polyisocyanate (5) is preferably used in deficiency even in the presence of compounds (7)—to ensure that all the isocyanate groups, which represent a health hazard, will completely react. The amounts in which organic compounds (5) are used in the second step are therefore preferably in the range from 0.5 to 1.0 mol, more preferably in the range from 0.8 to 1.0 mol of isocyanate group per mole of the sum total of isocyanate-reactive functions from the sum total of intermediate (4) and compounds (7).

The second step is preferably carried out at the pressure of the ambient atmosphere, i.e., at 1020 hPa (absolute), but can also be carried out at higher or lower pressures. Furthermore, the second step is preferably carried out at a temperature in the range from 40° C. to 140° C. and more preferably at a temperature in the range from 60° C. to 100° C.

To reduce the sometimes high product viscosities, low molecular weight compounds, such as alcohols or ethers, can be added if appropriate. Examples thereof are ethanol, isopropanol, n-butanol, 2-butoxyethanol, diethylene glycol monobutyl ether, tetrahydrofuran, diethylene glycol diethyl ether and dimethoxyethane, of which diethylene glycol monobutyl ether is a preferred example. Preferred quantities added in the case of very viscous products are up to 50% by weight and more preferably up to 30% by weight, based on the hydrophilic siloxane copolymers of the present invention. Such additives also have the advantage that the resultant products are easier to disperse in water than the pure siloxane copolymers. The siloxane copolymers of the present invention are generally easy to disperse in water without further auxiliaries, such as emulsifiers, however, i.e., are self-dispersing, and can produce emulsions and especially microemulsions.

The emulsion's content of the present invention's siloxane copolymers is preferably in the range from 20% to 60% and more preferably in the range from 30% to 50% by weight, prior to addition to the highly ionic agrochemical formulation.

The emulsions, preferably microemulsions, of the present invention are produced by mixing of

(A) siloxane copolymers according to the present invention, with

(B) water.

Technologies for producing silicone emulsions are known. Silicone emulsions are typically produced by simply stirring the siloxane copolymers of the present invention with water and if appropriate subsequent homogenization with rotor-stator homogenizers, colloid mills or high pressure homogenizers.

The amount of defoamer employed in the high electrolyte agrochemical formulation is an amount necessary to substantially reduce foaming, e.g. to obtain a foam height as measured in the examples, of 0-10 cm after 60 seconds, more preferably 0-5 cm. Importantly, this defoaming activity should preferably remain within these ranges following storage for 1 month at 25° C. The amount of the inventive defoamer(s) used is preferably in an amount of 0.001 to 5 weight percent based on defoamer “solids,” relative to the total formulation weight, more preferably 0.01 to 1 weight percent, and most preferably 0.02 to 0.5 weight percent. Amounts in the range of 0.02 to 0.10 weight percent are particularly useful, and amounts of about 0.05 weight percent have been found to be exemplary. Thus, only a relatively small amount of defoamer need be used.

### Example 1

### Comparative Defoamer

960 g of an α,ω-dihydropolydimethylsiloxane having a content of silicon bonded hydrogen of 0.055 weight percent having a water content of 50 weight ppm are mixed with 536 g of a polyether of the formula

H₂C═CH—CH₂—(OCH₂CH₂)_{10.2}—OH,

having a water content of 686 weight ppm, and heated to 100° C. 0.28 g of Karstedt's catalyst is then added, whereupon the temperature of the reaction mixture rises to 19° C. and a clear product is formed. Complete conversion of the silicon-bonded hydrogen is achieved after one hour at 100 to 110° C. The polyether-polysiloxane intermediate has a viscosity of 760 mm²/s at 25° C.

63 g of N-methyldiethanolamine (1.02 mol of HO group per mole of HO group in the polyether) and 178 g of hexamethylene diisocyanate (0.99 mol of isocyanate group per mole of the sum total of HO groups in the intermediate and the N-methyldiethanolamine) are then metered in succession. Urethane formation is catalyzed with 100 mg of di-n-butyltin dilaurate. After the batch is held at 100° C. for 2 hours it is cooled down and 64 g of acetic acid are added at 70° C. The clear, brownish product has a viscosity of 120,000 mPa·s at 25° C.

40 g of the highly viscous oil are mixed with 60 g of water at 50° C. Gentle stirring produces a microemulsion having a urethane content of 0.39 meq./g and an amine number of 0.12 (the amine number is the number of ml of 1N HCl needed to neutralize 1 g of substance).

### Example 2

### Inventive Defoamer

1411 g of a polyoxyethylene polyoxypropylene monol allyl ether having about 20 oxyethylene and 20 oxypropylene groups are mixed with 813 g of an α,ω-dihydropolydimethylsiloxane having 0.052% by weight of silicon-bonded hydrogen and heated to 100° C. in the presence of a catalyst as described in Example 1 with thorough stirring. The resulting polyether-polysiloxane intermediate has a viscosity of 2490 mm²/s at 25° C. after a reaction time of one hour.

At 100° C., 83 g of N,N-bis(3-dimethylaminopropyl)-N-isopropanolamine are stirred in and 92 g of hexamethylene diisocyanate are metered in. The ratio of NCO groups to the sum total of NCO-reactive organic groups is 0.995 or, taking into account the water present therein, about 0.87. A somewhat exothermic reaction is followed by heating to 120° C., at which point 50 mg of dibutyltin laurate are added and the reaction is allowed to proceed for a further 3 hours until isocyanate is no longer detectable in the IR, while the viscosity increases at the same time. The oil, which is very viscous at 25° C., has a basic nitrogen content of 0.42 meq./g.

### Example 3

### Inventive Defoamer

Example 1 is repeated, but by replacing the N-methyldiethanolamine in stage 2 by 99 g of bis(dimethylaminopropyl)amine, and using the polyether of Example 2. The amount of hexamethylene diisocyanate is reduced to 131 g (0.98 mol of isocyanate per mole of the sum total of isocyanate-reactive OH and NH groups). Following complete conversion of all isocyanate groups, the batch is neutralized with 70 g of acetic acid and diluted with 450 g of diethylene glycol monobutyl ether.

A total of 60 g of water is stirred a little at a time into 40 g of this solution at room temperature to form a fine emulsion.

### Example 4

### Inventive Defoamer

1492 g of the polyether polysiloxane intermediate of Example 2 are mixed with 51 g of bis(dimethylaminopropyl)amine and 67 g of hexamethylene diisocyanate at 100° C. The slightly exothermic reaction gives complete conversion of the NCO groups after two hours. Neutralization with 35 g of acetic acid and further dilution with 410 g of diethylene glycol monobutyl ether gives a clear formulation having a viscosity of 7800 mm²/s (25° C.) and an amine number of 0.26.

60 g of water are easily stirred into 40 g of this dilution. The aqueous formulation has an amine number of 0.104.

In the Examples which follow, the following are used:

Defoamer A (comparative) is a urethane linked polydimethylsiloxane containing polyoxethylene groups having about 10 repeating oxyethylene groups and N,N-bis(3-aminopropyl)amine groups, as terminal groups or in-chain groups, preparable analogously to Example 1.

Defoamer B (inventive) is a urethane linked polydimethylsiloxane containing polyoxyethylenepolyoxypropylene groups with about 20 repeating oxyethylene and 20 repeating oxypropylene groups, and N,N-bis(3-aminopropyl)-N-isopropanol amine groups as terminal groups or in-chain groups, available from Wacker Chemie AG as WETSOFT® NE 820, as a neat liquid.

Defoamer C (comparative) is a trimethylsiloxy end-capped polydimethylsiloxane bearing pendent glycidoxy groups and pendent hydroxyl-terminated polyoxyethylenepolyoxypropylene groups with about 20 repeating oxyethylene and oxypropylene units, and a degree of polymerization of about 70.

Defoamer D (comparative) is a trisiloxane bearing a pendent propylene-linked methyl-capped polyoxyethylene group with 6 repeating oxyethylene units.

Defoamer E (comparative) is a trimethylsiloxy end-capped polydimethylsiloxane with about 40-50 siloxy units, about one fourth of which bear acetate end-capped, propylene-linked polyoxyethylene groups with about 6 repeating oxyethylene groups.

Defoamer F (inventive) is a trimethylsiloxy-capped polydimethylsiloxane with a degree of polyerization of about 70, containing about 2 mol precent of N,N-bis(2-hydroxyethyl)-N-(2-hydroxy)-4-oxa-heptyl groups and slightly fewer alkylene-linked hydroxyl-terminated polyoxyethylene polyoxypropylene groups having about 20 oxyethylene and 20 oxypropylene groups.

Defoamer G (comparative) is a polydimethylsiloxane bearing terminal and pendent acylated N-(2-aminoethyl)aminopropyl groups.

Defoamer H (comparative) is a trimethylsiloxy end-capped polydimethylsiloxane bearing pendent acylated N-(2-aminoethyl)aminopropyl groups.

Defoamer I (comparative) is a silanol-stopped polydimethylsiloxane with pendent N-(2-aminoethyl)aminopropyl groups with a nominal amine number of 0.3 and a nominal viscosity of 4500 mPA·s.

Defoamer J is a 40% aqueous emulsion of defoamer I.

The examples illustrate the effectiveness and stability of the claimed defoamers relative to other defoamers not having the claimed characteristics. In these tests, a high electrolyte agrochemical composition containing glyphosate as the active agrochemical ingredient was tested for foaming properties and propensity for separation. Separation was evaluated by adding defoamer at 0.05 weight percent (based on defoamer solids) to the herbicide formulation in a glass flask, and storing for two weeks at 54° C. Presence or absence of an oily film was noted. The results are present in Table 1.

TABLE 1

| | | INITIAL ROOM | 2 WEEK RATING |
|---|---|---|---|
| | | TEMPERATURE | OVEN @ 54° C. |
| DEFOAMER | CONC | OBSERVATIONS | OBSERVATIONS |
| NO DEFOAMER | | CLEAR | CLEAR |
| A (COMP.) | 0.05% | CLEAR | CLEAR |
| B (INVENTIVE) | 0.05% | CLEAR | CLEAR |
| C (COMP.) | 0.05% | CLEAR | CLEAR; VERY |
| | | | SLIGHT |
| | | | OIL ON GLASS |
| D (COMP.) | 0.05% | CLEAR | CLEAR |
| E (COMP.) | 0.05% | CLEAR | CLEAR; FAINT OIL |
| | | | ON GLASS |
| F (INVENTIVE) | 0.05% | CLEAR | CLEAR |
| G (COMP.) | 0.05% | CLEAR | CLEAR; SOME OIL |
| | | | ON GLASS |
| H (COMP.) | 0.05% | CLEAR | CLEAR; SOME OIL |
| | | | ON GLASS |
| I (COMP.) | 0.05% | CLEAR | CLEAR; HEAVY OIL |
| | | | ON GLASS |
| J (COMP.) | 0.10% | CLEAR | CLEAR; HEAVY OIL |
| | | | ON GLASS |

Foaming behavior was evaluated accordance with Collaborative International Pesticides Analytical Council (CIPAC) test method MT 47.2 Water with a hardness of 342 mg/L, calculated as calcium carbonate by method WHO/M/29 was used. The aqueous formulations were introduced into a capped 100 ml graduated cylinder and inverted 30 times within 60 seconds. Initial foam height and foam height after 60 seconds were measured. The results are presented in Table 2. The tests were repeated after 2 weeks of room temperature storage. The results are presented in Table 3.

TABLE 2

| | | | 60 SECONDS |
|---|---|---|---|
| | | INITIAL FOAM | FINAL FOAM |
| DEFOAMER | CONC | HEIGHT ML | HEIGHT ML |
| NO DEFOAMER | | 24 | 12 |
| A (COMP.) | 0.05% | 20 | 8 |
| B (INVENTIVE) | 0.05% | 20 | 0-3 |
| C (COMP.) | 0.05% | 22 | 8 |
| D (COMP.) | 0.05% | 20 | 0-4 |
| E (COMP.) | 0.05% | 20 | 0-4 |
| F (INVENTIVE) | 0.05% | 20 | 0-3 |
| G (COMP.) | 0.05% | 20 | 0-2 |
| H (COMP.) | 0.05% | 20 | 0 |
| I (COMP.) | 0.05% | 20 | 12 |
| J (COMP.) | 0.10% | 20 | 0-3 |

TABLE 3

| | | | 60 SECONDS |
|---|---|---|---|
| | | INITIAL FOAM | FINAL FOAM |
| DEFOAMER | CONC | HEIGHT ML | HEIGHT ML |
| NO DEFOAMER | | 20 | 13 |
| A (COMP.) | 0.05% | 18 | 10 |
| B (INVENTIVE) | 0.05% | 15 | 4 |
| C (COMP.) | 0.05% | | |
| D (COMP.) | 0.05% | 20 | 12 |
| E (COMP.) | 0.05% | 20 | 12 |
| F (INVENTIVE.) | 0.05% | 16 | 6 |

The inventive and comparative examples illustrate that both an alkylamine having tertiary amino groups as well as a polyether moiety containing both polyoxyethylene and polyoxypropylene moieties are necessary for defoaming and stability.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A high electrolyte aqueous agrochemical composition resistant to foaming, comprising:
a) at least one agrochemical active:
b) at least one surfactant; and
c) an effective defoaming amount of at least one stable defoamer containing
organopolysiloxane groups, tertiary aminoalkyl groups or an ammonium salt thereof, and at least one of
c)i) polyether group(s) containing both polyoxyethylene moieties and polyoxyalkylene moieties where the alkylene groups are propylene or butylene groups or both;
and/or
c)ii) both at least one polyoxyethylene polyether group and at least one polyoxy(propylene and/or butylene) polyether group.

2. The composition of claim 1, wherein the stable defoamer contains in-chain polyoxyethylenepolyoxypropylene groups, and wherein said tertiary aminoalkyl groups are chain-terminal tertiary aminoalkyl groups, or an ammonium salt thereof.

3. The composition of claim 1, wherein at least one tertiary aminoalkyl group is a chain-pendant aminoalkyl group, or an ammonium salt thereof.

4. The composition of claim 1, wherein at least one of said tertiary aminoalkyl groups is linked to the defoamer by a urethane or urea group.

5. The composition of claim 1, wherein at least one tertiary aminoalkyl group has the formula
R₂N—(R¹—NR²)n—R^{1′}—
wherein
R is a hydrocarbon group or an alkanol group;
R¹ and R^{1′} each independently is a divalent hydrocarbon radical optionally containing heteroatoms, and
R² is hydrogen or a hydrocarbon group.

6. The composition of claim 1, wherein at least one tertiary amino group has one of the formulae

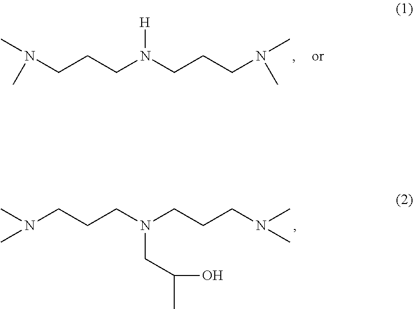

7. The composition of claim 1, wherein a terminal group of the defoamer is an alkyl-terminated, urethane-linked polyoxyethylenepolyoxypropylene glycol.

8. The composition of claim 1, wherein the defoamer is present in an amount of from 0.001 to 5 weight percent based on the total weight of the composition.

9. The composition of claim 1, wherein the defoamer is present in an amount of from 1 to 5 weight percent based on the total weight of the composition.

10. The composition of claim 1, which is a rich electrolyte composition having a conductance of 1 mS/cm or more at 25° C.

11. The composition of claim 1, wherein the composition has an ionic content of at least one mole of ions per liter.

12. The composition of claim 1, wherein the agrochemical active is a glyphosate salt.

13. The composition of claim 1, wherein the composition contains at least one soluble inorganic salt.

14. A method for decreasing foaming in a dilutable high electrolyte agrochemical formulation comprising at least one agrochemical active and susceptible to foaming upon dilution with water, the method comprising adding to said high electrolyte formulation, a defoaming effective amount of an effective defoaming amount of
c) at least one stable defoamer containing organopolysiloxane groups, tertiary aminoalkyl groups or an ammonium salt thereof, and at least one of
c)i) polyether group(s) containing both polyoxyethylene moieties and polyoxyalkylene moieties where the alkylene groups are propylene or butylene groups or both;
and/or
c)ii) both at least one polyoxyethylene polyether group and at least one polyoxy(propylene and/or butylene) polyether group.

15. The method of claim 14, wherein the stable defoamer is present in an amount of from 0.01 weight percent to 1 weight percent based on the weight of the dilutable high electrolyte agrochemical formulation.

16. The method of claim 14, wherein at least one of said tertiary aminoalkyl groups is linked to the defoamer by a urethane or urea group.

17. The method of claim 14, wherein at least one tertiary aminoalkyl group has the formula
R₂N—(R¹—NR²)n—R^{1′}
wherein
R is a hydrocarbon group or an alkanol group;
R¹ and R^{1′} each independently is a divalent hydrocarbon radical optionally containing heteroatoms, and
R² is hydrogen or a hydrocarbon group.
